(19) United States
(12) Patent Application Publication
(10) Pub. No.: US 2015/0084986 A1
(43) Pub. Date: Mar. 26, 2015

(54) COMPOSITOR, SYSTEM-ON-CHIP HAVING THE SAME, AND METHOD OF DRIVING SYSTEM-ON-CHIP

(71) Applicants: Kil-Whan Lee, Seoul (KR); Yong-Kwon Cho, Yongin-si (KR)

(72) Inventors: Kil-Whan Lee, Seoul (KR); Yong-Kwon Cho, Yongin-si (KR)

(21) Appl. No.: 14/475,612

(22) Filed: Sep. 3, 2014

(30) Foreign Application Priority Data
Sep. 23, 2013 (KR) 10-2013-0112791

(51) Int. Cl. G06T 11/60

(52) U.S. Cl. CPC G06T 11/60
USPC 345/629

(57) ABSTRACT

A compositor selects a subset of image layers from a plurality of image layers with which to form an intermediate image. The compositor forms a resultant image from an intermediate image and one or more remaining image layers.

### CROSS-REFERENCE TO RELATED APPLICATION

This application claims priority under 35 U.S.C. §119 to Korean Patent Application No. 10-2013-0112791 filed on Sep. 23, 2013, the disclosure of which is hereby incorporated by reference in its entirety.

### BACKGROUND

1. Field

Exemplary embodiments in accordance with principles of inventive concepts relate to a compositor, and more particularly, to a hardware compositor.

2. Description of Related Art

A compositor combines visual elements from separate sources into a single image. An early example of compositing is the use in television broadcasting of “blue screen” to combine the image of a weatherman with that of a weather map, allowing the combined image to give the appearance of having the weatherman interact with the weather map. Compositing has evolved to a substantially digital process, employing computer-generated imagery. Such imagery may be used in any of a variety of applications, including, not only more conventional entertainment (for example, television broadcasting, motion pictures, animation, etc.) applications, but graphics used in computers, smart televisions, and entertainments systems for everything from word processing to computer gaming, to sophisticated simulation processes, to user interfaces in mobile electronic devices. As such applications have increased in complexity, more and more image layers may be incorporated in a single image, each image may be increasingly complex and of greater resolution, and management of all image components from a variety of applications and user interfaces has become a daunting task. Processors referred to as hardware compositors may be employed to accelerate the compositing process. Such compositors may be two-dimensional or three-dimensional (that is, may be employed to produce two- or three-dimensional images), and may employ a variety of technologies, including hardware, firmware, software, application specific, graphics processing, digital signal processing, or other technologies, for example.

Conventional compositors typically compose a single image by operating on two image layers to produce a resultant image (for example, combing a weatherman and weather map). In order to compose an image having more than two image layers (think of adding an exterior storm shot, for example) such a compositor must repeat the process for each additional image layer.

### SUMMARY

Exemplary embodiments in accordance with principles of inventive concepts provide a compositor capable of generating an intermediate image based on update information regarding each of a plurality of image layers, and generating a resultant image using the intermediate image.

Exemplary embodiments in accordance with principles of inventive concepts also provide a system-on-chip (SoC) including the compositor and a method of driving the SoC.

Exemplary embodiments in accordance with principles of inventive concepts also provide a mobile device including the SoC.

The technical objectives of the inventive concept are not limited to the above disclosure; other objectives may become apparent to those of ordinary skill in the art based on the following descriptions.

In accordance with an aspect of the inventive concept, a compositor includes a sorter configured to sort first, second, and third image layers based on update information thereof and select the first and second image layers according to a result of sorting the first to third image layers; and an intermediate image generator configured to generate an intermediate image by performing composition on the selected first and second image layers.

In exemplary embodiments, the compositor may further include a resultant image generator configured to generate a resultant image by performing composition on the intermediate image and the third image layer.

In exemplary embodiments, the intermediate image generator generates the intermediate image in consideration of an alpha blending rule.

In exemplary embodiments, the intermediate image generator does not generate the intermediate image when the first and second image layers satisfy the alpha blending rule.

In exemplary embodiments, the update information may include information indicating whether the first to third image layers are updated; update rates of the first to third image layers; or a composition rule.

In exemplary embodiments, the update rates may include information regarding frames per second (FPS).

In exemplary embodiments, an FPS of each of the first and second image layers may be less than an FPS of the third image layer.

In exemplary embodiments, the composition rule may include a blend function.

In exemplary embodiments, the composition may include blending.

In accordance with another aspect of the inventive concept, a system-on-chip (SoC) includes a compositor configured to sort first to third image layers based on update information thereof, select the first and second image layers according to a result of sorting the first to third image layers, generate an intermediate image by performing composition on the selected first and second image layers, and generate a resultant image by performing composition on the intermediate image and the third image layer; and a memory configured to store the resultant image generated by the compositor.

In exemplary embodiments, the compositor generates the intermediate image in consideration of an alpha blending rule, and does not generate the intermediate image when the first and second image layers satisfy the alpha blending rule.

In exemplary embodiments, the update information may include information indicating whether the first to third image layers are updated; update rates of the first to third image layers; or a composition rule.

In exemplary embodiments, the update rate may include information regarding frames per second (FPS), and an FPS of each of the first and second image layers may be less than an FPS of the third image layer.

In exemplary embodiments, the composition rule may include a blend function.

In accordance with another aspect of the inventive concept, a mobile device includes a system-on-chip (SoC), and a display device configured to receive the resultant image from the memory and display the resultant image thereon. The SoC includes a compositor configured to sort first to third image layers based on update information thereof, select the first and second image layers according to a result of sorting the first to third image layers, generate an intermediate image by performing composition on the selected first and second image layers, and generate a resultant image by performing composition on the intermediate image and the third image layer; and a memory configured to store the resultant image generated by the compositor; and

In exemplary embodiments, the compositor may generate the intermediate image in consideration of an alpha blending rule, and may not generate the intermediate image when the first and second image layers satisfy the alpha blending rule.

In exemplary embodiments, the update information may include information indicating whether the first to third image layers are updated; update rates of the first to third image layers; and a composition rule.

In exemplary embodiments, the update rate may include information regarding frames per second (FPS), and an FPS of each of the first and second image layers may be less than an FPS of the third image layer.

In exemplary embodiments, the compositor may decrease a bandwidth of the SoC by reading the intermediate image.

In accordance with another aspect of the inventive concept, a method of driving a system-on-chip (SoC) includes sorting first to third image layers based on update information thereof, and generating an intermediate image by performing composition on the first and second image layers, based on a result of sorting the first to third image layers.

In exemplary embodiments, the method may further include generating a resultant image by performing composition on the intermediate image and the third image layer.

In exemplary embodiments, the sorting of the first to third image layers based on the update information thereof may include sorting the first to third image layers based on information indicating whether the first to third image layers are updated, update rates of the first to third image layers, and a composition rule.

In exemplary embodiments, the sorting of the first to third image layers based on the update information thereof may include selecting the first and second image layers

In exemplary embodiments, the generating of the intermediate image may include generating the intermediate image in consideration of an alpha blending rule. In exemplary embodiments, the method may further include preventing the intermediate image from being generated when the first and second image layers satisfy the alpha blending rule. In exemplary embodiments, the method may further include storing the resultant image in a memory, and transmitting the resultant image from the memory to a display device.

A compositor in accordance with principles of inventive concepts may include a sorter configured to sort a plurality of image layers based on update information thereof and select first and second image layers according to a result of sorting the first to third image layers; and an intermediate image generator configured to generate an intermediate image by performing composition on the selected first and second image layers.

A compositor in accordance with principles of inventive concepts may include a resultant image generator configured to generate a resultant image by performing composition on the intermediate image and the third image layer.

A compositor in accordance with principles of inventive concepts may include an intermediate image generator, wherein the intermediate image generator generates the intermediate image according to an alpha blending rule.

A compositor in accordance with principles of inventive concepts may include intermediate image generator wherein the intermediate image generator does not generate an intermediate image when the first and second image layers satisfy the alpha blending rule.

In accordance with principles of inventive concepts update information comprises any one of: information indicating whether any image layers are updated; update rates of the image layers; and a composition rule.

In accordance with principles of inventive concepts update rates comprise information regarding frame per second (FPS).

In accordance with principles of inventive concepts FPS of each of the selected image layers is less than an FPS of the remaining image layer.

In accordance with principles of inventive concepts a composition rule comprises a blend function.

In accordance with principles of inventive concepts a composition comprises blending.

In accordance with principles of inventive concepts a system-on-chip (SoC) includes a compositor configured to sort a plurality of image layers based on update information thereof, select a subset of the layers according to a result of sorting the image layers, generate an intermediate image by performing composition on the selected image layers, and generate a resultant image by performing composition on the intermediate image and a remaining image layer; and a memory configured to store the resultant image generated by the compositor.

In accordance with principles of inventive concepts a compositor generates the intermediate image in consideration of an alpha blending rule, and does not generate the intermediate image when the selected image layers satisfy the alpha blending rule.

In accordance with principles of inventive concepts the update information comprises any one of: information indicating whether the selected image layers are updated; update rates of the image layers; and a composition rule.

In accordance with principles of inventive concepts the update rate comprises information regarding frame per second (FPS), wherein the FPS of each of the selected image layers is less than the FPS of the remaining image layer.

In accordance with principles of inventive concepts the composition rule comprises a blend function.

In accordance with principles of inventive concepts a mobile device includes a system-on-chip (SoC) that includes a compositor configured to sort a plurality of image layers based on update information thereof, select a subset of the image layers according to a result of sorting the image layers, generate an intermediate image by performing composition on the selected image layers, and generate a resultant image by performing composition on the intermediate image and a remaining image layer; and a memory configured to store the resultant image generated by the compositor; and a display device configured to receive the resultant image from the memory and display the resultant image thereon.

In accordance with principles of inventive concepts a compositor generates the intermediate image in consideration of an alpha blending rule, and does not generate the intermediate image when the selected image layers satisfy the alpha blending rule.

In accordance with principles of inventive concepts update information comprises any one of: information indicating whether the selected image layers are updated; update rates of the image layers; and a composition rule.

In accordance with principles of inventive concepts the update rate comprises information regarding frame per second (FPS), wherein the FPS of each of the selected image layers is less than the FPS of the third image layer.

In accordance with principles of inventive concepts the compositor decreases a bandwidth required of the SoC by reading the intermediate image.

In accordance with principles of inventive concepts a method of a system on a chip includes sorting a plurality of image layers based on update information thereof; selecting a subset of the image layers according to a result of the sorting; and generating an intermediate image by performing composition on the selected image layers.

A method in accordance with principles of inventive concepts includes generating a resultant image by performing composition on the intermediate image and a remaining image layer.

In accordance with principles of inventive concepts the sorting of image layers based on the update information thereof comprises sorting the image layers based on information indicating whether the image layers are updated, update rates of the image layers, and a composition rule.

In accordance with principles of inventive concepts the generating of the intermediate image comprises generating the intermediate image in consideration of an alpha blending rule.

A method in accordance with principles of inventive concepts includes preventing the intermediate image from being generated when the selected image layers satisfy the alpha blending rule.

A method in accordance with principles of inventive concepts includes storing the resultant image in a memory; and transmitting the resultant image from the memory to a display device.

An apparatus in accordance with principles of inventive concepts includes a processor configured to receive a plurality of image layers; the processor configured to composite a subset of the plurality of image layers to form an intermediate image; and the processor configure to composite the intermediate image and a remaining image layer to form a resultant image frame.

An apparatus in accordance with principles of inventive concepts a processor is configured to select the subset of the plurality of image layers with which to form the intermediate image based on the frame rates of the associated image layers.

An apparatus in accordance with principles of inventive concepts the processor is configured to select image layers having frame rates below a threshold value for compositing the intermediate image.

An apparatus in accordance with principles of inventive concepts the processor is configured to form an intermediate image layer according to a blending rule.

In accordance with principles of inventive concepts a smartphone includes a processor configured to receive a plurality of image layers; the processor configured to composite a subset of the plurality of image layers to form an intermediate image; and the processor configure to composite the intermediate image and a remaining image layer to form a resultant image frame.

### BRIEF DESCRIPTION OF THE DRAWINGS

The foregoing and other features and advantages of the inventive concepts will be apparent from the more particular description of preferred exemplary embodiments in accordance with principles of inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram of a mobile device in accordance with principles of inventive concepts;

FIG. 2 is a block diagram of a conventional compositor;

FIGS. 3A and 3B are conceptual diagrams illustrating composition operations of the conventional compositor of FIG. 2;

FIGS. 4A to 4C are conceptual diagrams illustrating operations of the conventional compositor of FIG. 2;

FIGS. 5A and 5B are block diagrams of compositors in accordance with principles of inventive concepts;

FIG. 6 is a detailed block diagram of the compositor illustrated in FIG. 5A;

FIGS. 7A to 7C illustrate a first image layer to a third image layer, respectively;

FIGS. 8A to 8C are conceptual diagrams illustrating operations of the compositor of FIG. 5A;

FIG. 9 is a conceptual diagram illustrating driving of a compositor in accordance with principles of inventive concepts;

FIG. 10 illustrates a result of driving the compositor of FIG. 9;

FIGS. 11A and 11B are conceptual diagrams illustrating composition performed according to an alpha blending rule;

FIG. 12 is a flowchart illustrating a method of driving a compositor in accordance with principles of inventive concepts;

FIG. 13 is a block diagram of a computer system including a compositor illustrated in FIG. 1 in accordance with principles of inventive concepts;

FIG. 14 is a block diagram of a computer system including the compositor of FIG. 1 in accordance with another embodiment of the inventive concept; and

FIG. 15 is a block diagram of a computer system including the compositor of FIG. 1 in accordance with another embodiment of the inventive concept.

### DETAILED DESCRIPTION OF THE EMBODIMENTS

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The teen “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. In this manner, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with principles of inventive concepts will be explained in detail with reference to the accompanying drawings.

When an embodiment in accordance with principles of inventive concepts may be accomplished in different ways, a function or an operation specified in a particular block may be performed in an order that is different from that illustrated in a flowchart. For example, functions or operations specified in continuous two blocks may be actually substantially simultaneously performed or may be performed in a reverse order according to a related function or operation.

A compositor produces an image that combines image layers, each of which may have a different update rate. A moving weatherman in one image layer may be updated much more frequently than a relatively static weather map in another image layer or an external weathercam image from another image layer, for example. A compositor may employ a composition rule, such as a blend function. A blend function may control various mixing factors when image layers are overlapped. A blend function may include a variety of modes, such as a normal blend mode, a dissolve mode, multiply, screen, overlay, hard light, soft light, dodge and burn, arithmetic blend modes, including: divide, add, subtract, difference, darken only, lighten only, Boolean blend modes, a color burn mode, and a linear burn mode, for example. Blend modes are known and described, for example, at: http://en.wikipedia.org/wiki/Blend_modes.

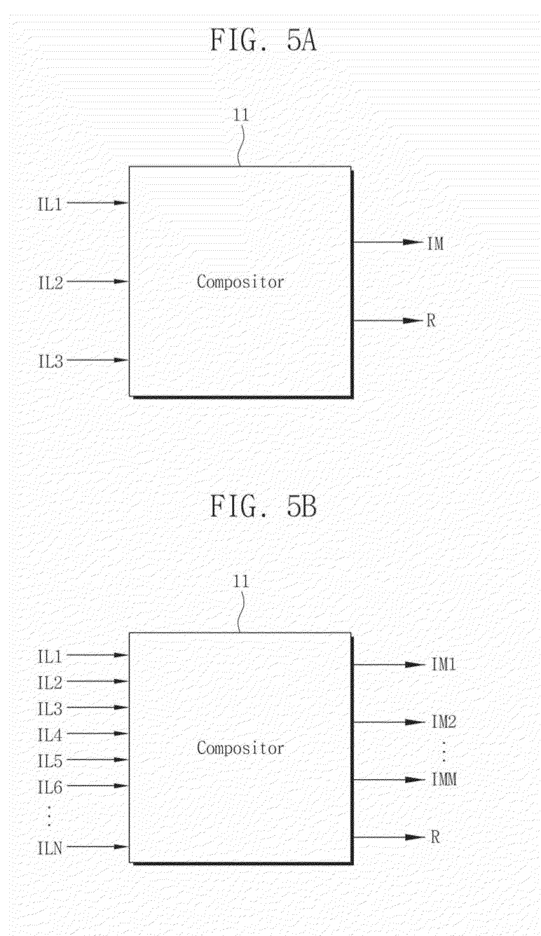

Exemplary embodiments of a compositor in accordance with principles of inventive concepts may consider one or more image layer update rates in the process of compositing. For example, such a compositor may generate an intermediate image from a plurality of image layers of relatively low update rates and generate a resultant image from the intermediate image and a relatively high update-rate image layer. By compositing an intermediate image at a relatively low rate and then compositing the intermediate image with another, higher-rate image layer, a compositor in accordance with principles of inventive concepts may reduce overhead and increase bandwidth. An exemplary embodiment of a compositor in accordance with principles of inventive concepts will be described with reference to FIGS. 5A to 12 below.

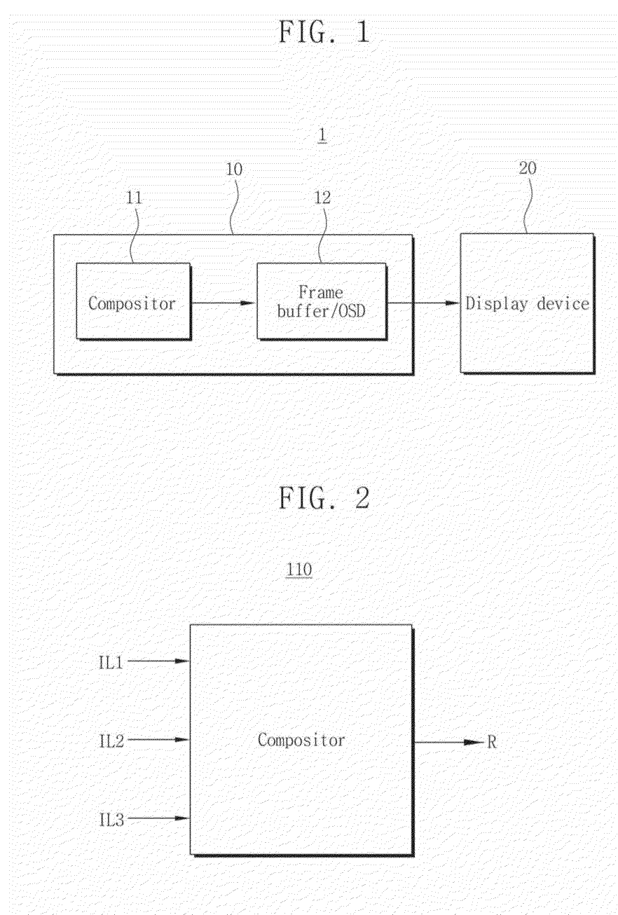

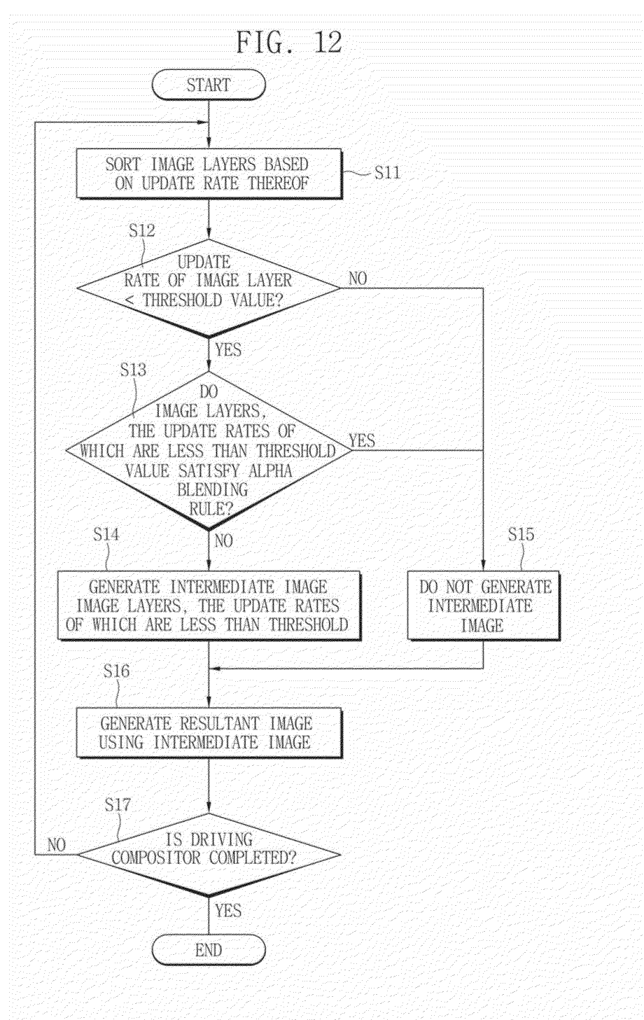

In exemplary embodiments of a system-on-chip (SoC) and a method of driving the same a compositor is employed in accordance with principles of inventive concepts. Exemplary embodiments of a SoC and a method of driving the same will be described with reference to FIGS. 1 and 12 below.

FIG. 1 is a block diagram of an exemplary embodiment of a mobile device 1 in accordance with principles of inventive concepts. Mobile device 1 may include a SoC 10 and a display device 20. In exemplary embodiments mobile device 1 may include a smart-phone, a tablet personal computer (PC), a net-book, an e-reader, a personal digital assistant (PDA), a portable multimedia player (PMP), etc.

The SoC 10 may include a compositor 11 configured to perform composition on a plurality of image layers, and a frame buffer/on-screen-display (OSD) 12 configured to store a result of performing composition on the plurality of image layers, the result may also referred to herein as a “composition,” “composite image,” or “composed image.” In exemplary embodiments, frame buffer/OSD 12 transmits a final composite image, also referred to herein as a resultant image, to the display device 20. The frame buffer/on-screen-display (OSD) 12 may be embodied using a memory. That is, the memory may be used as a frame buffer.

In exemplary embodiments in accordance with principles of inventive concepts, compositor 11 may select one or more of a plurality of received image layers and generates an intermediate image using the selected images, with the selection of image layers based, for example, on update information related to the layers. For example, image layers with relatively low update rates (that is, those in which images are relatively static) may be combined to form an intermediate image, or image layer. The intermediate image may then be combined with a relatively high update rate image layer to produce another image, which may be the ultimate, resultant image, or another intermediate image layer, for example. By producing intermediate image layers only so often as is required by the update rates of slower-update image layers (the faster of two slower update rates, for example) and compositing the thus-formed intermediate image with a higher update-rate image layer, at the rate required by that higher update-rate layer a compositor in accordance with principles of inventive concepts avoids substantial processing that would otherwise be performed if, for example, every image layer, including the lower update-rate layers, were composited at the rate of the highest update-rate image layer. The compositor 11 may use an intermediate image to generate a resultant image.

Compositor 11 in accordance with principles of inventive concepts may avoid generating an intermediate image according to an alpha blending rule. An alpha blending rule may be a rule related to the combination of an alpha channel with other layers in an image in order to show translucency, for example. In accordance with principles of inventive concepts, because the compositor 11 may generate a resultant image from an intermediate image, the number of times that each of the plurality of image layers is read and composited may be reduced and, as a result, the bandwidth of the SoC 10 in accordance with principles of inventive concepts may be improved. Compositor 11 in accordance with principles of inventive concepts will be described with reference to FIGS. 5A to 12 below. A conventional compositor 110 will described with reference to FIGS. 2 to 4C below in order to better illustrate some differences that may be employed by a compositor in accordance with principles of inventive concepts.

FIG. 2 is a block diagram of a conventional compositor 110, which receives first to third image layers IL1 to IL3 and performs composition on the first to third image layer IL1 to IL3 to generate a resultant image. That is, all image layers are employed to form a composite image at the rate required by the highest update-rate of all the image layers IL1 to IL3.

The term composition may be used herein to mean, in this context, arranging the first to third image layers IL1 to IL3 in a predetermined order. For example, the conventional compositor 110 may arrange the first to third image layers IL1 to IL3 such that the second image layer IL2, the third image layer IL3, and the first image layer IL1 are sequentially disposed. Composition may include blending, which refers to determining the way that an upper image layer and a lower image layer are viewed in an overlapping manner. That is, blending means changing the way that image layers are viewed without “causing damage to,” eliminating, or completely obstructing the image layers or portions thereof.

The conventional compositor 110 receives and employs all image layers each time a resultant image is generated.

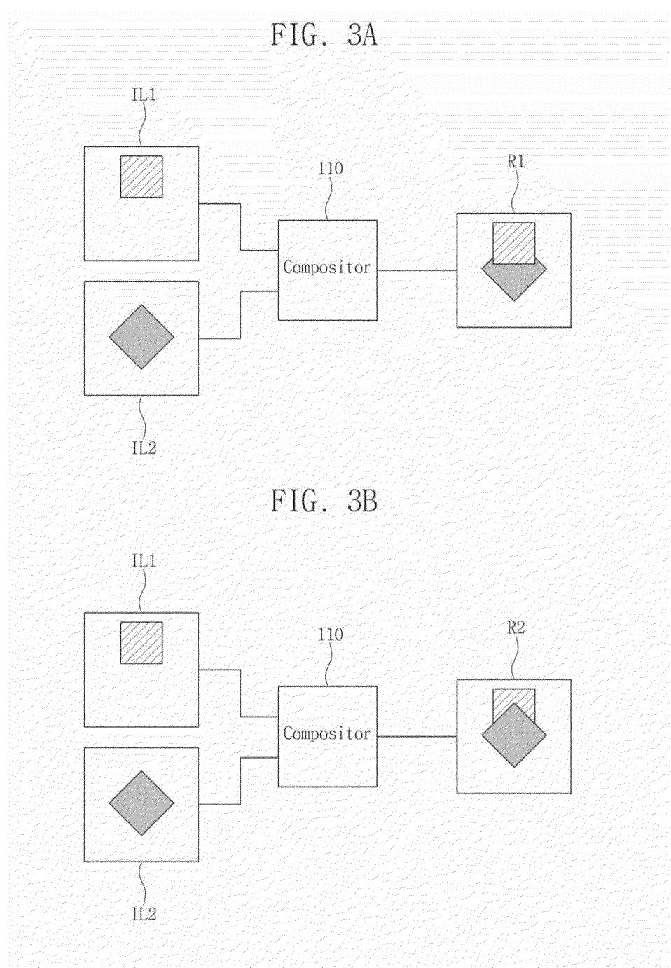

FIGS. 3A and 3B are conceptual diagrams illustrating composition operations of the conventional compositor 110 of FIG. 2.

Referring to FIG. 3A, the conventional compositor 110 performs composition on a first image layer IL1 and a second image layer IL2. For example, if it is assumed that the first image layer IL1 is located above (in the sense of being closer to the viewer of the image) the second image layer IL2, the conventional compositor 110 generates a first resultant image R1, with a portion of image IL1 obstructing a portion of image layer IL2, as would occur if the object of image layer IL1 were lain on top of (“above”) image layer IL2.

Referring to FIG. 3B, the conventional compositor 110 performs composition on the first image layer IL1 and the second image layer IL2. For example, if it is assumed that the first image layer IL1 is located below (in the sense of being farther from the view of the image) the second image layer IL2, the conventional compositor 110 generates a second resultant image R2.

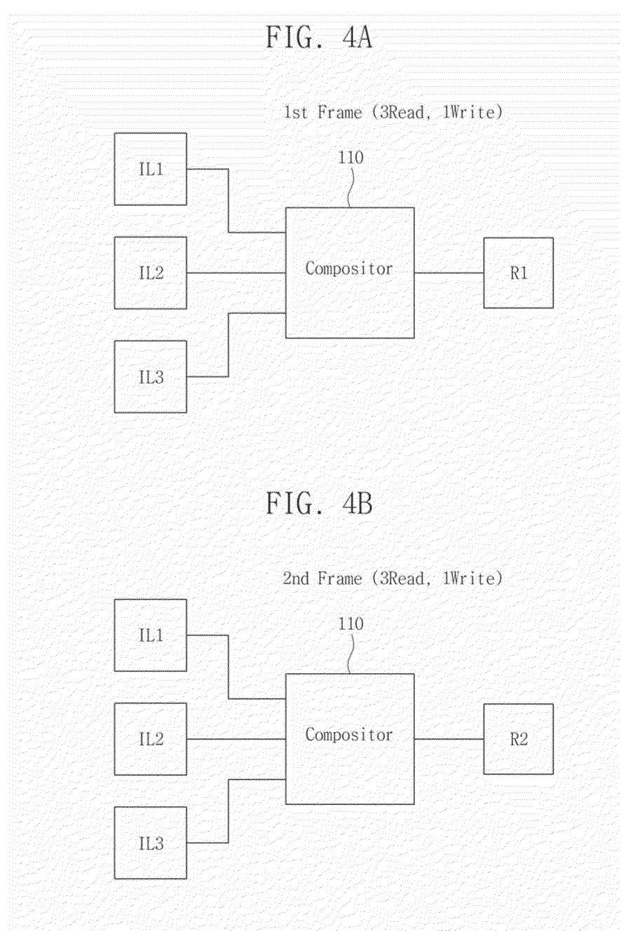

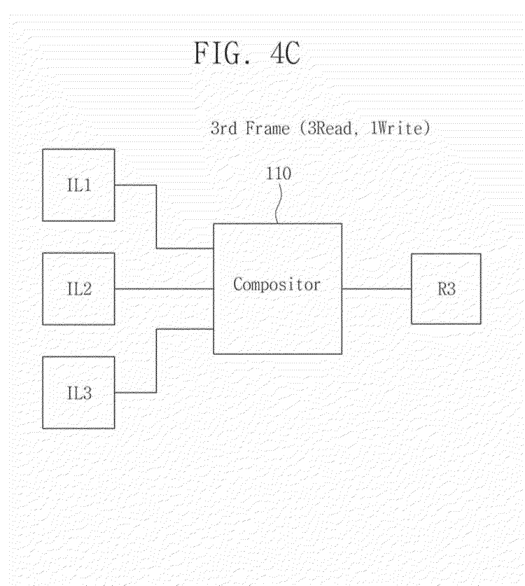

FIGS. 4A to 4C are conceptual diagrams illustrating operations of the conventional compositor 110 of FIG. 2.

FIG. 4A illustrates an operation of the conventional compositor 110 during a period of a first frame. FIG. 4B illustrates an operation of the conventional compositor 110 during a period of a second frame. FIG. 4C illustrates an operation of the conventional compositor 110 during a period of a third frame. Each frame may, for example, be a frame for display in sequence to thereby form the illusion of motion, as in motion pictures, for example.

Referring to FIG. 4A, the conventional compositor 110 receives first to third image layers IL1 to IL3 during the period of the first frame then generates a first resultant image R1 using the received first to third image layers IL1 to IL3. During the period of the first frame, the conventional compositor 110 reads the three image layers IL1 to IL3 and writes one resultant image R1.

Referring to FIG. 4B, the conventional compositor 110 receives first to third image layer IL1 to IL3 during the period of the second frame then generates a second resultant image R2 using the received first to third image layers IL1 to IL3. During the period of the second frame, the conventional compositor 110 reads the three image layers IL1 to IL3 and writes one resultant image R2.

Referring to FIG. 4C, the conventional compositor 110 receives first to third image layers IL1 to IL3 during the period of the third frame then generates a third resultant image R3 from the first to third image layers IL1 to IL3. During the period of the third frame, the conventional compositor 110 reads the three image layers IL1 to IL3 and writes one resultant image R3.

Referring to FIGS. 4A to 4C, in this example, the conventional compositor 110 reads nine image layers and writes three resultant images during the periods of the first through third frames.

FIGS. 5A and 5B are block diagrams of exemplary embodiments of compositors in accordance with principles of inventive concepts. Compositor 11 in accordance with principles of inventive concepts may consider one or more image layer update rates in the process of compositing. For example, such a compositor may generate an intermediate image from a plurality of image layers of relatively low update rates and generate a resultant image from the intermediate image and a relatively high update-rate image layer. By compositing an intermediate image at a relatively low rate and then compositing the intermediate image with another, higher-rate image layer, a compositor in accordance with principles of inventive concepts may reduce overhead and increase bandwidth. In an exemplary embodiment employing three image layers, compositor 11 in accordance with principles of invent receives first to third image layers IL1 to IL3. The compositor 11 sorts the first to third image layers IL1 to IL3 according to update information thereof. In exemplary embodiment, the update information of each of the first to third image layers IL1 to IL3 may include information indicating whether each of the first to third image layers IL1 to IL3 is updated, an update rate of the each of the first to third image layers Il1 to IL3, or a composition rule.

The compositor 11 selects at least two image layers based on a result of sorting the first to third image layers IL1 to IL3. For example, when the first to third image layers IL1 to IL3 are sorted according to the update rates (i.e., update speeds) thereof, the compositor 11 may generate an intermediate image IM by performing composition on two image layers of relatively low update rates among the first to third image layers IL1 to IL3. Then the compositor 11 may generate a resultant image R by performing composition on the intermediate image IM and the other image layer of a highest update rate. In accordance with principles of inventive concepts, the compositing of the plurality of lower update-rate image layers may be performed at a rate that satisfies requirements for the highest update rate of those layers, which rate may still be lower than that of the highest overall update rate. The intermediate image layer may then be composited with the highest update rate image layer(s) to produce resultant images at the rate required for such image layer

In exemplary embodiments, the update rate includes information regarding a frame per second (FPS) and, in accordance with principles of inventive concepts, a composition rule may include a blend function. A blend function may control various mixing factors when image layers are overlapped. A blend function may include a variety of modes, such as a normal blend mode, a dissolve mode, multiply, screen, overlay, hard light, soft light, dodge and burn, arithmetic blend modes, including: divide, add, subtract, difference, darken only, lighten only, Boolean blend modes, a color burn mode, and a linear burn mode, for example.

The blend function is a function of producing various effects by controlling various mixing factors when image layers overlap. For example, the blend function may include a normal mode in which mixed image layers are directly displayed, a dissolved mode in which an image is displayed by dividing the image in units of pixels and a pixel that is to be displayed is randomly selected among blend pixels and base pixels, a darken mode in which a color that is lighter than blend colors is replaced with another color and a color that is darker than a blend colors is not replaced with another color, a multiply mode in a blend color and a base color are expressed by multiplying them, a color burn mode in which a base color is controlled to be darker and a blend color is reflected by increasing a contrast, and a linear burn mode in which a base color is controlled to be darker and a blend color is reflected by decreasing brightness, etc.

For example, if the first image layer IL1 has 1 FPS, the second image layer IL2 has 20 FPS, and the third image layer IL3 has 60 FPS, the compositor 11 generates an intermediate image IM using the first and second image layers IL1 and IL2 at a rate of 20 FPS (or at a slightly higher rate, 21 FPS, for example, in order to provide margin). The compositor 11 generates the resultant image R by compositing the intermediate image IM and the third image layer IL3 at a rate of 60 FPS. A compositor 11 reads image layer Il1 once per second, reads image layer IL2 twenty times per second and composites the two layers twenty times per second to form an intermediate layer twenty times per second. Then it reads intermediate layer twenty times per second and image layer IL3 sixty times per second and composites the two layers to form resultant images sixty times per second. In contrast, a conventional compositor 110 generates a resultant image, using all layers each time, at the highest image layer update rate. For example, if the first image layer IL1 has 1 FPS, the second image layer IL2 has 20 FPS, and the third image layer IL3 has 60 FPS, the conventional compositor 110 reads each of the first to third image layers IL1 to IL3 sixty times per second and composites all layers to form a resultant image layer sixty times per second.

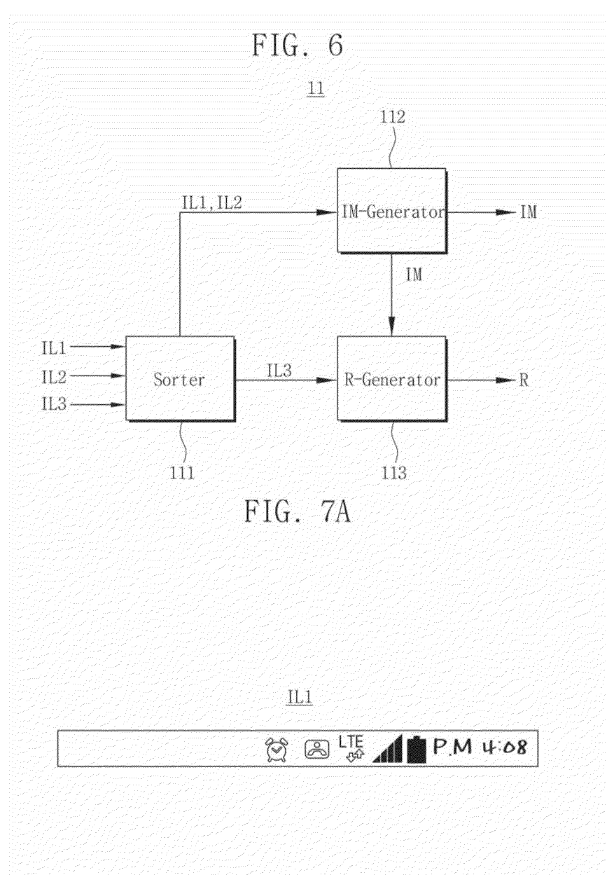

In contrast, the compositor 11 in accordance with principles of inventive concepts generates the intermediate image IM using image layers, the update rates of which are less than a threshold value, e.g., 21 FPS (as previously indicated, although the highest frame update rate of the lower update rate image layers is 20 FPS, one or more additional compositing operations may be executed per frame, for margin). Because the compositor 11 generates the resultant image R using the intermediate image IM, the number of times that the first and second image layers IL1 and IL2 are read may be relatively low and, as a result, the bandwidth required of a compositor 11 in accordance with principles of inventive concepts may be reduced and performance increased. Exemplary embodiments of a compositor 11 in accordance with principles of inventive concepts will be described in greater detail with reference to FIG. 6 below.

Referring to FIG. 5B, a compositor 11 in accordance with principles of inventive concepts may receive N image layers IL1 to ILN and may generate M intermediate images IM1 to IMM using a plurality of the N image layers IL1 to ILN. In exemplary embodiments in accordance with principles of inventive concepts, the compositor 11 may be embodied as one functional block included in an application processor. Additionally, a compositor 11 in accordance with principles of inventive concepts may be embodied as one semiconductor chip that constitutes a mobile electronic device, such as a mobile phone, smartphone, tablet computer, or notebook computer, for example.

FIG. 6 is a detailed block diagram of an exemplary embodiment of compositor 11 illustrated in FIG. 5A. Compositor 11 may include a sorter 111, an intermediate image generator 112, and a resultant image generator 113.

The sorter 111 selects image layers to be used to generate an intermediate image IM, based on an update rate of each image layer (first to third image layers IL1 to IL3 in this exemplary embodiment), whether each of first to third image layers IL1 to IL3 is updated, and a composition rule. In exemplary embodiments, the sorter 111 may be embodied as hardware, software, firmware, or a combination, such as software employed by a processor, for example, the ARM™ processor.

In accordance with principles of inventive concepts a compositor may employ image layers having update rates less than a threshold update rate to produce an intermediate image. For example, when image layers are selected based on the update rate of each of first to third image layers IL1 to IL3, the sorter 111 arbitrarily sets a threshold value to 21 FPS. With the first image layer IL1 at 1 FPS, the second image layer IL2 at 20 FPS, and the third image layer IL3 at 60 FPS, sorter 111 selects the first and second image layers IL1 and IL2, the FPSs of which are less than the threshold value to generate an intermediate image IM.

The intermediate image generator 112 generates the intermediate image IM using the first and second image layers IL1 and IL2 selected by the sorter 111. The resultant image generator 113 generates a resultant image R by performing composition on the intermediate image IM and the third image layer IL3.

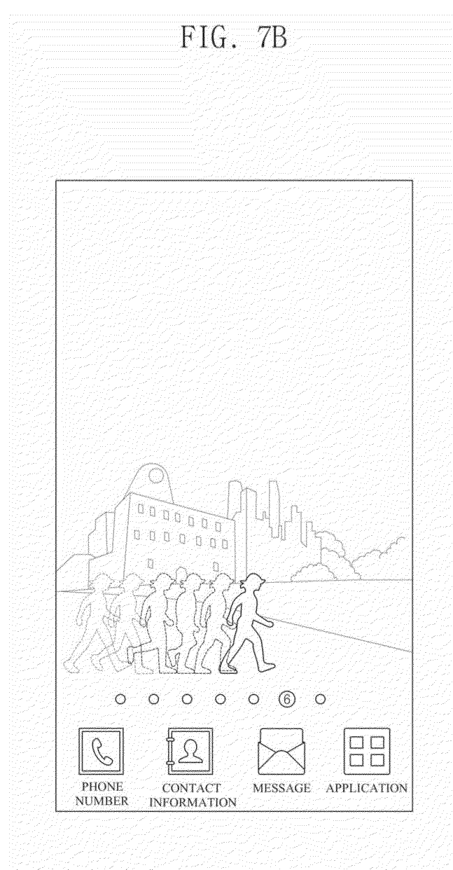

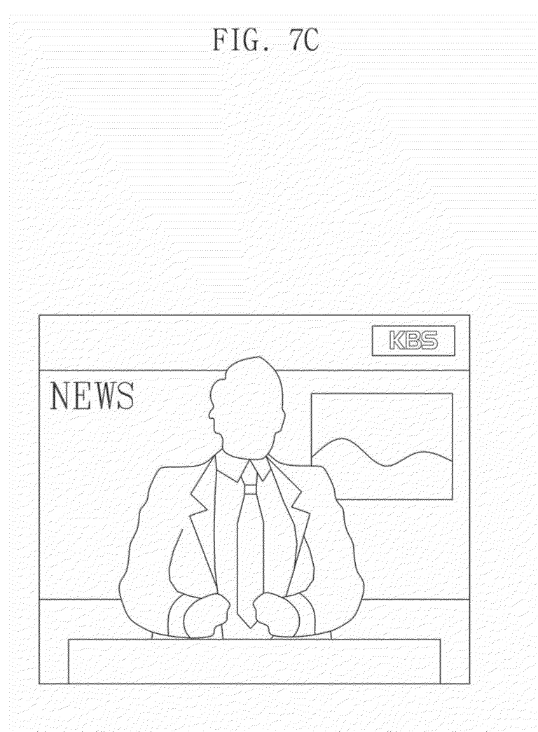

FIGS. 7A to 7C illustrate a first image layer IL1 to a third image layer IL3, respectively.

Referring to FIG. 7A, the first image layer IL1 in this exemplary embodiment is a status bar indicating the state of a mobile device. The status bar represents time information, the sensitivity of a transmission/reception signal, battery state information, etc. Thus, an update rate of the status bar may be relatively low. If the first image layer IL1 representing the status bar is updated by one frame for a second, the first image layer IL1 has an update rate of 1 FPS.

Referring to FIG. 7B, the second image layer IL2 in this exemplary embodiment is a background image of the mobile device. Examples of the background image may include a still image, a moving wallpaper image, etc. In general, the update rate of the moving wallpaper image may be lower than a video reproducing speed. If the second image layer IL2 is updated by 20 frames for a second, the second image layer IL2 has an update rate of 20 FPS.

Referring to FIG. 7C, the third image layer IL3 in this exemplary embodiment is video displayed on a screen of the mobile device. If the video is updated by 60 frames for a second, the third image layer IL3 has an update rate of 60 FPS.

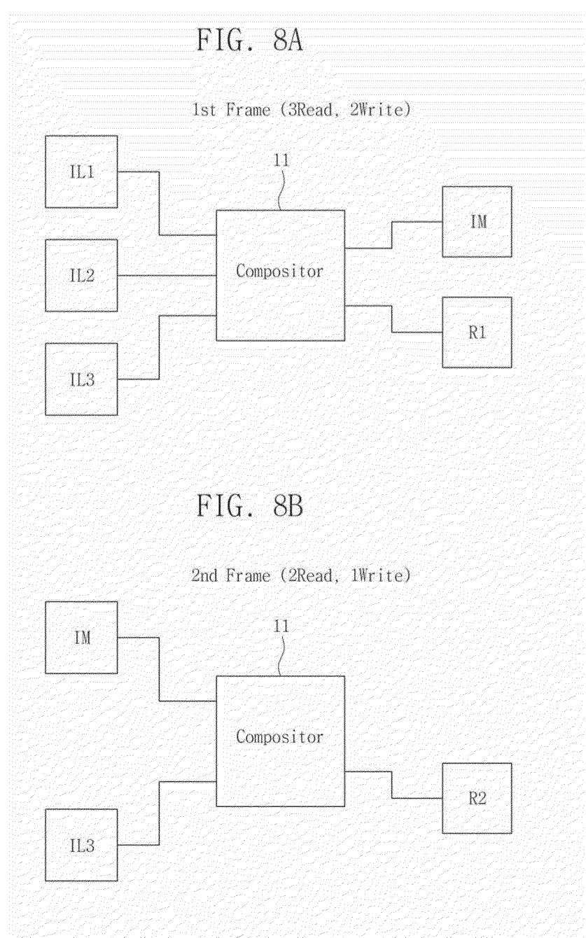

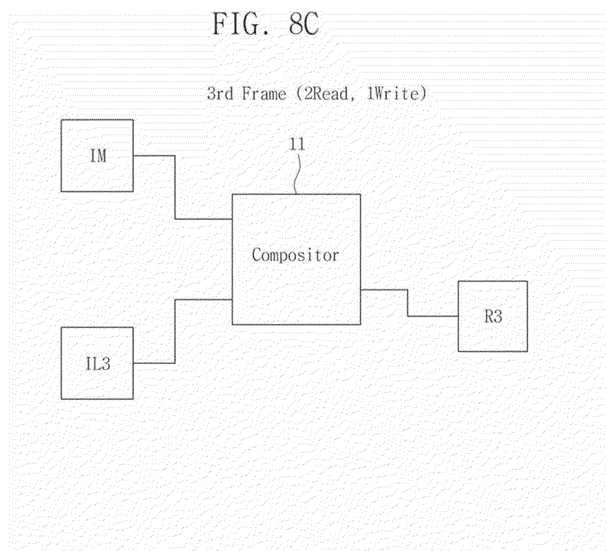

FIGS. 8A to 8C are conceptual diagrams illustrating operations of exemplary embodiments compositor 11 in accordance with principles of inventive concepts of FIG. 5A. FIG. 8A illustrates an operation of the compositor 11 during a period of a first frame. FIG. 8B illustrates an operation of the compositor 11 during a period of a second frame. FIG. 8C illustrates an operation of the compositor 11 during a period of a third frame.

Referring to FIG. 8A, during the period of the first frame, the compositor 11 receives first to third image layers IL1 to IL3. The compositor 11 generates an intermediate image IM and a first resultant image R1 using the first to third image layers IL1 to IL3. During the period of the first frame, the compositor 11 reads the three image layers IL1 to IL3 and writes one resultant image R1 and one intermediate image IM.

Referring to FIG. 8B, during the period of the second frame, the compositor 11 receives the intermediate image IM and the third image layer IL3. The compositor 11 generates a second resultant image R2 using the intermediate image IM and the third image layer IL3. During the period of the second frame, the compositor 11 reads the two images, IM and IL3, and writes one resultant image R2.

Referring to FIG. 8C, during the period of the third frame, the compositor 11 receives the intermediate image IM and the third image layer IL3. The compositor 11 generates a third resultant image R3 using the intermediate image IM and the third image layer IL3. During the period of the third frame, the compositor 11 reads the two image layers, IM and IL3, and writes one resultant image R3.

Referring to FIGS. 1 and 8A to 8C, the compositor 11 reads seven image layers and writes four resultant images during the periods of the first to third frames. As illustrated by this example, the compositor 11 in accordance with principles of inventive concepts may decrease the number of times that the image layers IL1 to IL3 are read (during the periods of the three frames in this exemplary embodiment). Additionally, the greater the number of frames, the greater the savings in the number of image layers read by the compositor 11. Accordingly, the bandwidth required of the SoC 10 of the compositor 11 may be reduced.

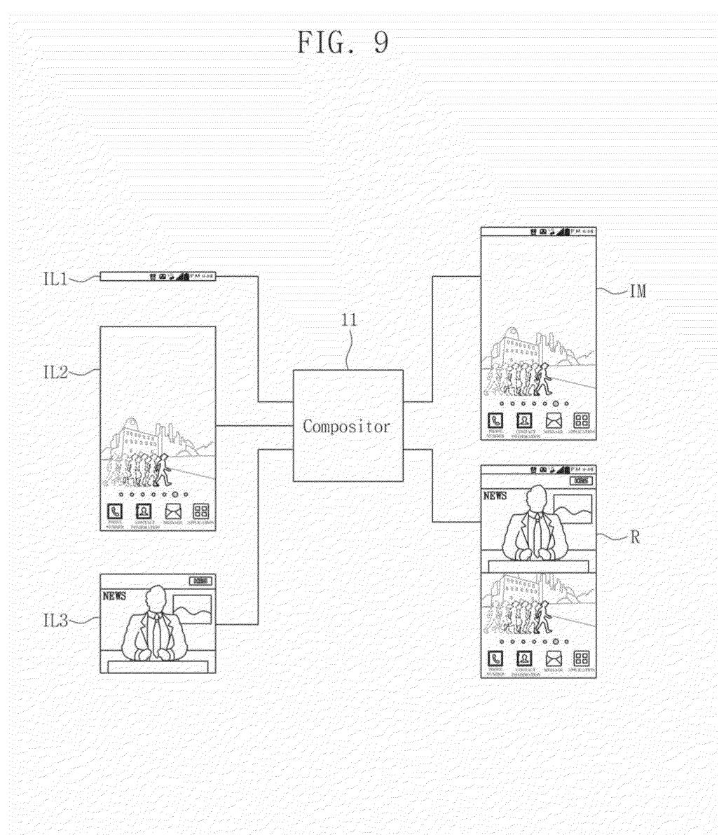

FIG. 9 is a conceptual diagram illustrating driving of a compositor in accordance with principles of inventive concepts.

In this exemplary embodiment first image layer IL1 is a status bar having an update rate of 1 FPS, a second image layer IL2 is a moving background image having an update rate of 20 FPS, and a third image layer IL3 is video having an update rate of 60 FPS.

The compositor 11 sorts the first to third image layers IL1 to IL3 according to a threshold value. If it is assumed that the threshold value is 21 FPS, the compositor 11 selects the first and second image layers IL1 and IL2, the FPSs of which are less than threshold value to composite an intermediate image IM. The compositor 11 generates the intermediate image IM using the first and second image layers IL1 and IL2. Additionally, the compositor 11 generates a resultant image R using the intermediate image IM and the third image layer IL3.

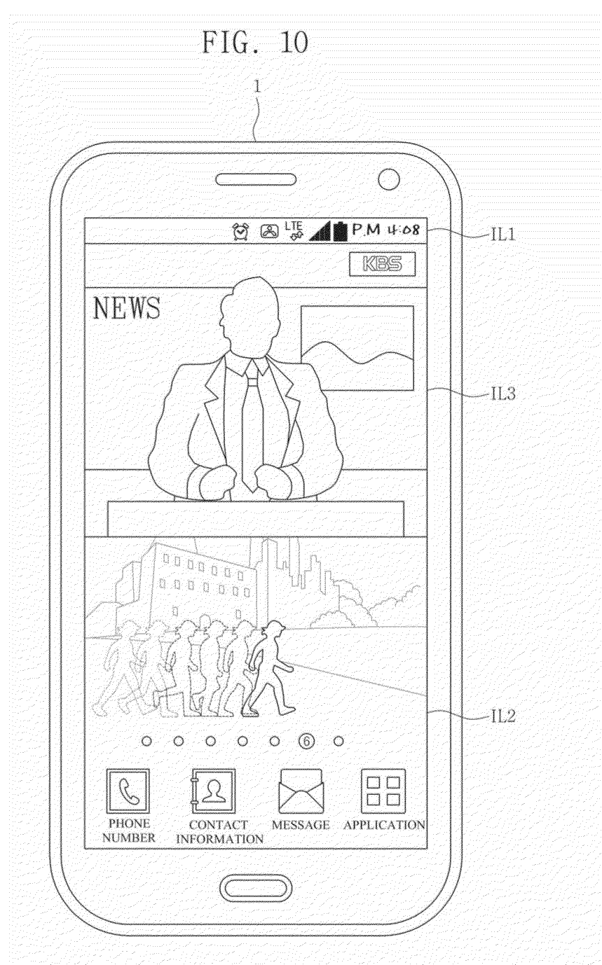

FIG. 10 illustrates a result of driving the compositor 11 of FIG. 9.

Referring to FIGS. 1 and 10, the mobile device 1 includes the SoC 10 including the compositor 11. The compositor 11 generates a resultant image R by performing composition on first to third image layers IL1 to IL3. The mobile device 1 displays the resultant image R on a screen thereof.

The mobile device 1 is capable of decreasing a bandwidth thereof by reducing the number of times that image layers are to be read. Accordingly, a decrease in the bandwidth dedicated to compositing by the mobile device 1 may result in an improvement in the performance of the mobile device 1.

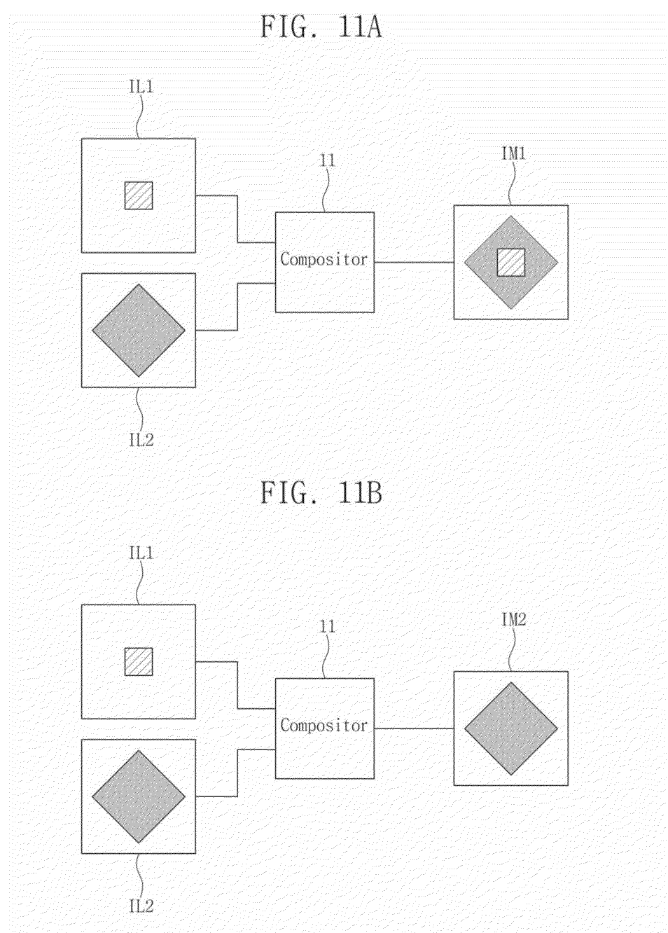

FIGS. 11A and 11B are conceptual diagrams illustrating composition performed according to an alpha blending rule. Alpha blending is a general method used to mix two images, in which the two images are mixed at an appropriate degree such that these images are viewed in an overlapping manner.

Referring to FIG. 11A, a compositor 11 performs composition on a first image layer IL1 and a second image layer IL2. For example, if it is assumed that the first image layer IL1 is located above, or, in front of, the second image layer IL2, the compositor 11 generates a first intermediate image IM1.

Referring to FIG. 11B, the compositor 11 performs composition on the first image layer IL1 and the second image layer IL2. For example, if it is assumed that the first image layer IL1 is located below, or, behind, the second image layer IL2, the conventional compositor 110 generates a second intermediate image IM2.

That is, when the second image layer IL2 is located above the first image layer ILL and the second image layer IL2 would totally obstruct the first image layer ILL the second intermediate image IM2 need not be generated. Thus, the compositor 11 in accordance with principles of inventive concepts generates the intermediate image IM in consideration of the alpha blending rule (e.g., the relationship between the locations of the first and second image layers IL1 and IL2).

For example, when the first and second image layers IL1 and IL2 used to generate the intermediate image IM satisfy the alpha blending rule in a manner in which one of the layers would be totally obstructed, the compositor 11 does not generate the intermediate image IM, or may use the image layer IL2 as the intermediate image IM.

FIG. 12 is a flowchart illustrating a method of driving a compositor in accordance with principles of inventive concepts.

Referring to FIGS. 9 and 12, in operation S11, the compositor 11 may sort a plurality of image layers according to update information (e.g., update rates) thereof.

In exemplary embodiments, the update rates may be set in the unit of a frame per second (FPS). For example, when a first image layer IL1 is an upper status bar, an update rate of the first image layer IL1 may be 1 FPS. When a second image layer IL2 is a moving background image, an update rate of the second image layer IL2 may be 20 FPS. When a third image layer IL3 is video, an update rate of the third image layer IL3 may be 60 FPS.

In operation S12, the compositor 11 determines whether the update rates of the first to third image layers IL1 to IL3 are less than a threshold value. Image layers, the update rates of which are less than the threshold value among the first to third image layers IL1 to IL3, are processed in operation S13. When the update rate of any one of the first to third image layers IL1 to IL3 is not less than the threshold value, operation S15 is performed.

In operation S13, the compositor 11 determines whether image layers, the update rates of which are less than the threshold value satisfy the alpha blending rule; in particular, in exemplary embodiments in accordance with principles of inventive concepts, an alpha blending rule in which one layer may be obscured by another when composited. Operation S15 is performed when these layers satisfy the alpha blending rule, and operation S14 is performed when these layers do not satisfy the alpha blending rule.

In operation S14, the compositor 11 generates an intermediate image IM using the image layers, the update rates of which are less than the threshold value. For example, when the threshold value is set to 21 FPS, the compositor 111 may generate the intermediate image IM by performing composition on the first image layer IL1 and the second image layer IL2.

In operation S15, the compositor 11 does not generate the intermediate image IM. For example, when the second image layer IL2 is an opaque image layer and the first image layer IL1 is completely covered with the second image layer IL2, the compositor 11 need not generate the intermediate image IM (that is, when the layer IL2 satisfies the alpha blending rule referred to above).

In operation S16, the compositor 11 generates a resultant image R using the intermediate image IM. That is, the compositor 11 generates the resultant image R by performing composition on the intermediate image IM and the third image layer IL3.

In operation S17, the compositor 11 determines whether any more image layers are to be composited. The method of driving the compositor 11 is completed when no more image layers are to be composited, otherwise the process returns to operation S11.

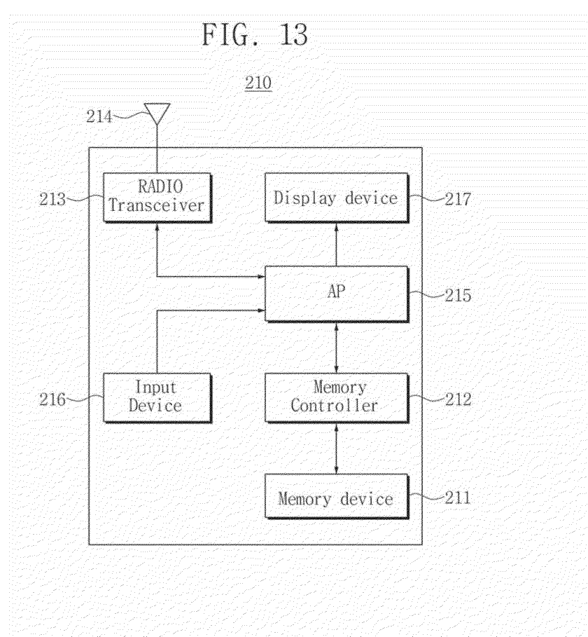

FIG. 13 is a block diagram of a computer system 210 including the compositor 11 illustrated in FIG. 1 in accordance with principles of inventive concepts. Computer system 210 includes a memory device 211, a memory controller 212 configured to control the memory device 211, a radio transceiver 213, an antenna 214, an application processor 215, an input device 216, and a display device 217.

The radio transceiver 213 may transmit or receive a radio signal via the antenna 214. For example, the radio transceiver 213 may convert the radio signal received via the antenna 214 into a signal that is to be processed by the application processor 215.

Thus, the application processor 215 may process a signal output from the radio transceiver 213 and transmit the processed signal to the display device 217. Also, the radio transceiver 213 may convert a signal output from the application processor 215 into a radio signal and output the radio signal to an external device via the antenna 214.

The input device 216 is a device via which a control signal for controlling an operation of the application processor 215 or data that is to be processed by the application processor 215 may be input, and may be embodied as a pointing device such as a touch pad and a computer mouse, a keypad, or a keyboard.

In exemplary embodiments in accordance with principles of inventive concepts, the memory controller 212 configured to control an operation of the memory device 211 may be embodied as a part of the application processor 215 or a chip installed separately from the application processor 215. Application processor 215 may be embodied to include the compositor 11 of FIG. 1.

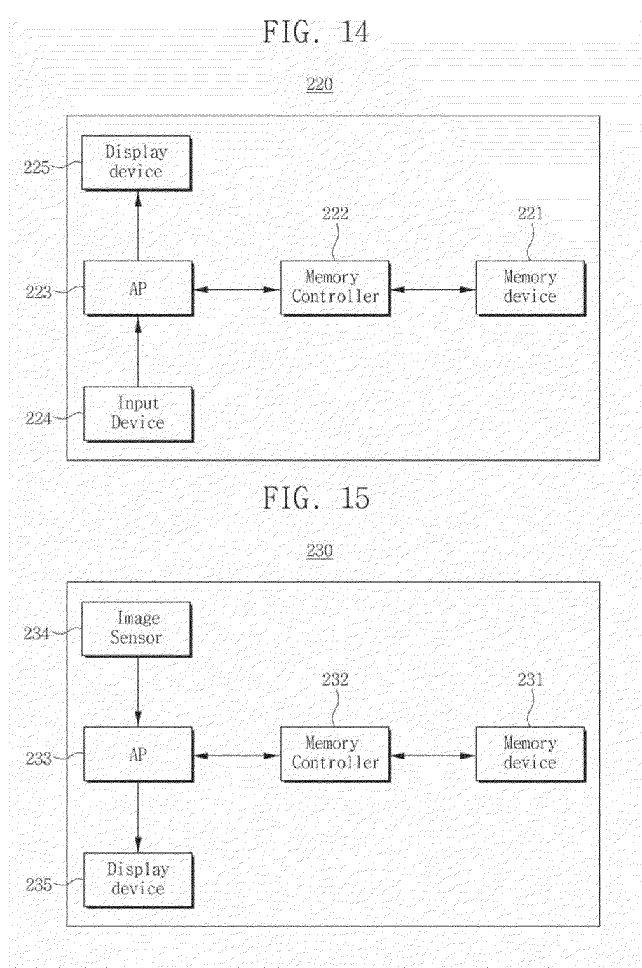

FIG. 14 is a block diagram of an exemplary embodiment of a computer system 220 including the compositor 11 of FIG. 1 in accordance with principles of inventive concepts. Computer system 220 may be embodied as a personal computer (PC), a network server, a tablet PC, a net-book, an e-reader, a PDA, a PMP, an MP3 player, or an MP4 player, for example. Computer system 220 includes a memory device 221, a memory controller 222 configured to control a data processing operation of the memory device 221, an application processor 223, an input device 224, and a display device 225.

The application processor 223 may display data stored in the memory device 221 on the display device 225 based on data received via the input device 224. For example, the input device 224 may be embodied as a pointing device such as a touch pad and a computer mouse, a keypad, or a keyboard. The application processor 223 may control overall operations of the computer system 220 and an operation of memory controller 222.

In exemplary embodiments, the memory controller 222 configured to control an operation of the memory device 221 may be embodied as a part of the application processor 223 or a chip installed separately from the application processor 223. Application processor 223 may be embodied to include a compositor in accordance with principles of inventive concepts, such as the compositor 11 described in the discussion related to FIG. 1.

FIG. 15 is a block diagram of a computer system 230 including compositor 11 of FIG. 1 in accordance with principles of inventive concepts. Computer system 230 may be embodied as an image process device, e.g., a digital camera or a cellular phone with a built-in digital camera, a smart phone, or a tablet PC, for example.

The computer system 230 includes a memory controller 232 capable of controlling the memory device 231 and a data processing operation (e.g., a write operation or a read operation) of the memory device 231. The computer system 230 may further include an application processor 233, an image sensor 234, and a display device 235.

The image sensor 234 of the computer system 230 converts an optical image into digital signals and transmits the digital signals to the application processor 233 or the memory controller 232. Under control of the application processor 233, the digital signals may be displayed on the display device 235 or stored in the memory device 231 via the memory controller 232.

The data stored in the memory device 231 may be displayed on the display device 235, under control of the application processor 233 or the memory controller 232.

In exemplary embodiments, the memory controller configured to control an operation of the memory device 231 may be embodied as a part of the application processor 233 or a chip installed separately from the application processor 233. Application processor 233 may be embodied to include a compositor in accordance with principles of inventive concepts, such as compositor 11 of FIG. 1.

Compositors in accordance with exemplary embodiments in accordance with principles of inventive concepts generate a resultant image using an intermediate image, thereby reducing the number of times that a plurality of image layers are read. Thus, a bandwidth required of a SoC including such as compositor may be reduced.

The foregoing is illustrative of embodiments and is not to be construed as limiting thereof. Although a few embodiments have been described, it will readily be appreciated that many modifications are possible in embodiments without materially departing from the novel teachings and advantages. It is to be understood that the foregoing is illustrative of various embodiments and is not to be construed as limited to the specific embodiments disclosed, and that modifications to the disclosed embodiments, as well as other embodiments, are intended to be included within the scope of the appended claims.

1. A compositor comprising:
a sorter configured to sort a plurality of image layers based on update information thereof and select first and second image layers according to a result of sorting the first to third image layers; and
an intermediate image generator configured to generate an intermediate image by performing composition on the selected first and second image layers.

2. The compositor of claim 1, further comprising a resultant image generator configured to generate a resultant image by performing composition on the intermediate image and the third image layer.

3. The compositor of claim 1, wherein the intermediate image generator generates the intermediate image according to an alpha blending rule.

4. The compositor of claim 3, wherein the intermediate image generator does not generate an intermediate image when the first and second image layers satisfy the alpha blending rule.

5. The compositor of claim 1, wherein the update information
information indicating whether any image layers are updated;
update rates of the image layers; and
a composition rule.

6. The compositor of claim 5, wherein the update rates comprise information regarding frame per second (FPS).

7. The compositor of claim 6, wherein FPS of each of the selected image layers is less than an FPS of the remaining image layer.

8. The compositor of claim 5, wherein the composition rule comprises a blend function.

9. The compositor of claim 1, wherein the composition comprises blending.

10. A system-on-chip (SoC) comprising:
a compositor configured to sort a plurality of image layers based on update information thereof, select a subset of the layers according to a result of sorting the image layers, generate an intermediate image by performing composition on the selected image layers, and generate a resultant image by performing composition on the intermediate image and a remaining image layer; and
a memory configured to store the resultant image generated by the compositor.

11. The SoC of claim 10, wherein the compositor generates the intermediate image in consideration of an alpha blending rule, and does not generate the intermediate image when the selected image layers satisfy the alpha blending rule.

12. The SoC of claim 10, wherein the update information comprises any one of:
information indicating whether the selected image layers are updated;
update rates of the image layers; and
a composition rule.

13. The SoC of claim 12, wherein the update rate comprises information regarding frame per second (FPS),
Wherein the FPS of each of the selected image layers is less than the FPS of the remaining image layer.

14. The SoC of claim 12, wherein the composition rule comprises a blend function.

15-25. (canceled)

26. An apparatus, comprising:
a processor configured to receive a plurality of image layers;
the processor configured to composite a subset of the plurality of image layers to form an intermediate image; and
the processor configured to composite the intermediate image and a remaining image layer to form a resultant image frame.

27. The apparatus of claim 26, wherein the processor is configured to select the subset of the plurality of image layers with which to form the intermediate image based on the frame rates of the associated image layers.

28. The apparatus of claim 27, wherein the processor is configured to select image layers having frame rates below a threshold value for compositing the intermediate image.

29. The apparatus of claim 26, wherein the processor is configured to form an intermediate image layer according to a blending rule.

30. A smartphone including the apparatus of claim 28.
